(19) United States
(12) Patent Application Publication
(10) Pub. No.: US 2004/0176045 A1
(43) Pub. Date: Sep. 9, 2004

(54) Method and device for producing mobile radio signals

(76) Inventor: Frank Lillie, Munchen (DE)

Correspondence Address: BELL, BOYD & LLOYD, LLC, P. O. BOX 1135, CHICAGO, IL, 60690-1135, US

(21) Appl. No.: 10/483,868

(22) PCT Filed: May 23, 2002
(86) PCT No.: PCT/DE02/01899

(30) Foreign Application Priority Data
Jul. 10, 2001 (DE) 101 33 514.8

(51) Int. Cl. H04B 1/40

(52) U.S. Cl. 455/76

(57) ABSTRACT

A method is provided for producing mobile radio signals using DDS (direct digital frequency synthesis) and a modulator, wherein the method includes the following steps: A) an intermediate frequency is produced by controlling the DDS using a DDS control word and a DDS clock pulse frequency, and B) the intermediate frequency is transformed into an emission frequency of the mobile radio signals, using the modulator, according to a reference frequency of the modulator. According to the present invention, the reference frequency of the modulator is used as a DDS clock pulse frequency, the frequency being unmodified or divided by a division factor. In order to produce the intermediate frequency, the DDS control word is selected in such a way that it compensates fluctuations of the reference frequency of the modulator.

The present invention relates to a method for generating mobile radio signals using a DDS (direct digital synthesizer) and a modulator, comprising the following steps:

A) Generating an intermediate frequency by controlling the DDS with a DDS control word and a DDS clock frequency and

B) Using the modulator to convert the intermediate frequency to a transmit frequency of the mobile radio signals as a function of a reference frequency of said modulator.

Mobile radio signals are transmitted from a mobile station to a base station as RF signals with a specific transmit frequency. To synthesize such signals with a desired frequency—for example, an RF transmit frequency in the 900 or 1800/1900 MHz bands in accordance with the current GSM standard—it is usual to obtain same by mixing, multiplying or dividing base frequencies. The base frequencies are generally derived from a crystal-controlled oscillator used as a frequency standard and which oscillates stably at e.g. 26 MHz. This base frequency is used directly or after modification for generating the mobile radio signals.

For example, in a mobile radio terminal as mentioned above, an intermediate frequency is produced from the base frequency by means of a DDS (direct digital synthesizer) and then undergoes further processing. The DDS is controlled via a DDS control word and a DDS clock frequency, generation of the intermediate frequency being essentially based on a counting process performed in the DDS. In said counting process a counter is incremented by the control word in time with the DDS clock frequency until said counter has reached an invariant maximum value (phase accumulator width) inherent to the DDS, whereupon it is reset possibly with an initial value corresponding to the overflow of the preceding counting cycle. Depending on the design of the DDS, either the reaching of the maximum value by the counter or the progress of incrementing the counter is used to generate a signal at the intermediate frequency. This signal therefore depends on the DDS clock frequency and the control word.

For practical reasons, the intermediate frequency signal delivered by the DDS is then converted to the mobile radio transmit frequency range by a following modulator, e.g. an offset phase locked loop (O-PLL). Two oscillators are required for this purpose, one providing a reference frequency which is used in the feedback control of another voltage controlled transmit oscillator.

Generating mobile radio signals in the manner described above is relatively expensive in terms of hardware. In particular it should be taken into account that at least three frequency oscillators were required for the above implementation, namely a frequency oscillator for generating the DDS clock frequency, a frequency oscillator for generating the reference frequency for the O-PLL and a frequency oscillator for generating the transmit frequency. However, this hardware complexity runs counter to the trend of producing RF transceiver chips for the mass market which require a minimal number of external components and combine high circuit performance with good reproducibility. For this purpose it is necessary to reduce the number of individual circuit components as much as possible. Moreover, it is a circuit design objective to use as few oscillators as possible, as these adversely affect circuit performance e.g. by introducing harmonics, crosstalk or the like.

The object of the present invention is therefore to provide a method of the kind specified at the outset which enables the number of oscillators required to be reduced.

This object is achieved by a method for generating mobile radio signals using a DDS and a modulator, comprising the following steps:

A) Generating an intermediate frequency by controlling the DDS with a DDS control word and a DDS clock frequency and

B) Using the modulator to convert the intermediate frequency to a transmit frequency of the mobile radio signals as a function of a reference frequency of said modulator, it being provided according to the invention that the reference frequency of the modulator—unchanged or divided by a division factor—is used as the DDS clock frequency, the DDS control word being selected in order to generate the intermediate frequency in such a way that is compensates for variations in the modulator's reference frequency.

By using the reference frequency of the modulator following the DDS as the DDS clock frequency, it is possible to dispense with the oscillator assigned to the DDS for supplying said clock frequency. This simplifies the design of a corresponding circuit and improves its performance and reproducibility. Although with the solution according to the invention the problem arises that the modulator's reference frequency may fluctuate, particularly if said reference frequency is produced by a channel synthesizer for generating regularly changing frequency channels for the mobile radio signals, this problem can be overcome with the solution according to the invention by selecting the current DDS control word in such a way that it contains not only the information for producing a required intermediate frequency but also additional information enabling the variations in the modulator's reference frequency to be compensated. This makes it possible for a signal with a desired intermediate frequency and having sufficiently good stability to be produced by means of a DDS. This frequency can then be upconverted by the modulator to a desired transmit frequency, e.g. 900 MHz or 1800/1900 MHz in the case of the GSM standard. The invention therefore shows how the circuit of an RF transmit chip can be simplified by using the reference frequency of a modulator following the DDS to generate the DDS clock frequency.

In a development of the invention it can be provided that the reference frequency of the modulator can be generated in the channel synthesizer by converting a variable output frequency of a voltage controlled oscillator to the reference frequency. Conversion to the reference frequency can be performed by a synthesizer phase locked loop (PLL).

As stated above, the DDS control word must be determined according to the current reference frequency of the modulator, as expressed by the following relation:

S=[f_{out-DDs}/f_{clk-DDS}]·2^{N},

where

S is the control word,

f_{out-DDS} the intermediate frequency,

f_{clk-DDS} the DDS clock frequency and

N the phase accumulator width of the DDS.

With constant phase accumulator width N of the DDS, the control word S must therefore be calculated from the required intermediate frequency and the currently obtaining clock frequency which is directly dependent on the reference frequency of the modulator. The calculation can be performed with relatively low hardware complexity.

As an alternative to computing the DDS control word from the parameters currently obtaining, i.e. the intermediate frequency and DDS clock frequency, it can be provided according to the invention that the DDS control word is determined from a previously stored table as a function of the current DDS clock frequency and the required intermediate frequency. This variant of the invention may be selected, for example, if sufficient storage space is available at acceptable cost.

In a development of the invention it can be provided that the DDS control word is generated from an output signal of another modulator, in particular a GMSK modulator. In this case the DDS control word contains information about the frequency modulation by the other modulator, the intermediate frequency and the compensation of the variation in the modulator's reference frequency. However, the method according to the invention is specifically independent of the type of other modulator used, so that other kinds of modulators can be used instead of a GMSK modulator.

The invention further relates to an arrangement for generating mobile radio signals, particularly in accordance with the method of the type described above, comprising:

a DDS (direct digital synthesizer) for generating an intermediate frequency from a DDS control word and a DDS clock frequency and

a modulator for converting the intermediate frequency to a transmit frequency of the mobile radio signals as a function of a reference frequency of the modulator.

For this arrangement it is provided that the DDS clock frequency is derived from the modulator's reference frequency and that the DDS control word is selected according to the reference frequency of said modulator.

In a development of the arrangement according to the invention a channel synthesizer can be provided for generating frequency channels of the mobile radio signals, the output frequency of the channel synthesizer—unchanged or divided by a division factor—being fed to the modulator as reference frequency and to the DDS as DDS clock frequency. It can further be provided according to the invention that the channel synthesizer has an oscillator, preferably a voltage controlled oscillator, and a synthesizer phase locked loop following said VCO.

In order to match the reference frequency of the modulator to the given requirements for controlling the DDS, in another development of the arrangement according to the invention there is provided a frequency divider for dividing down the reference frequency of the modulator to the required DDS clock frequency, the divider being either a conventional frequency divider or another DDS.

As indicated above, the DDS control word can be calculated or read out of a previously stored table. Depending on the solution selected, with the arrangement according to the invention it can therefore be provided that it incorporates a computation unit for computing the DDS control word or a storage unit for storing and reading out a table which specifies the DDS control word as a function of the current DDS clock frequency and the required intermediate frequency.

According to the invention it can be provided that the modulator is implemented as a phase locked loop, in particular as an offset PLL. This produces an easily integratable and inexpensively implementable circuit design for upconverting the intermediate frequency. However, other types of possibly open-loop modulators are also conceivable means of upconverting the intermediate frequency.

It can further be provided that the arrangement according to the invention comprises another modulator, in particular a GMSK modulator, which is connected upstream of the DDS for generating a DDS control word.

The arrangement according to the invention can be controlled by a superordinate control unit acting e.g. on the other modulator, the DDS, and the channel synthesizer.

The invention will now be explained using examples with reference to the accompanying drawings:

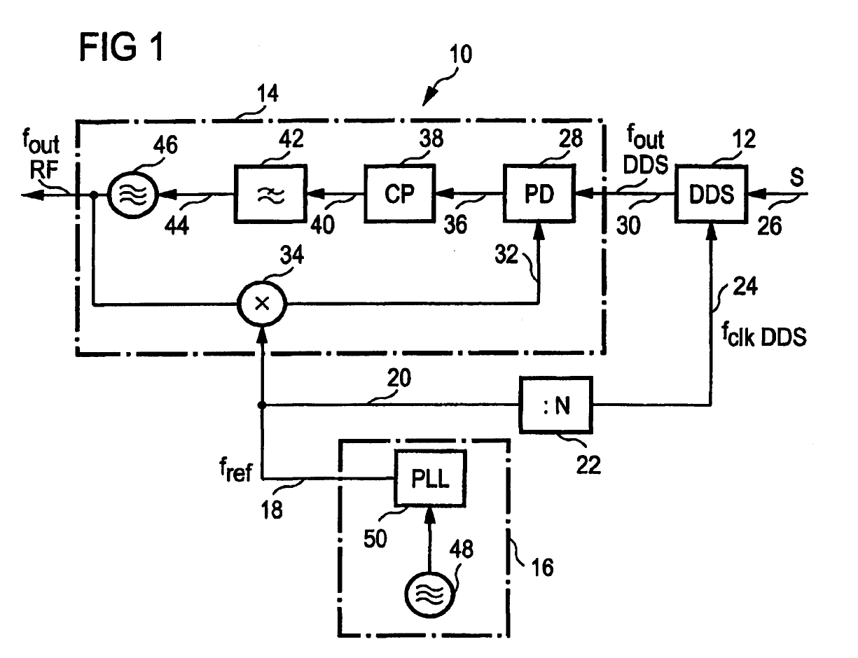

FIG. 1 is a block diagram showing one possibility for implementing the method according to the invention; and

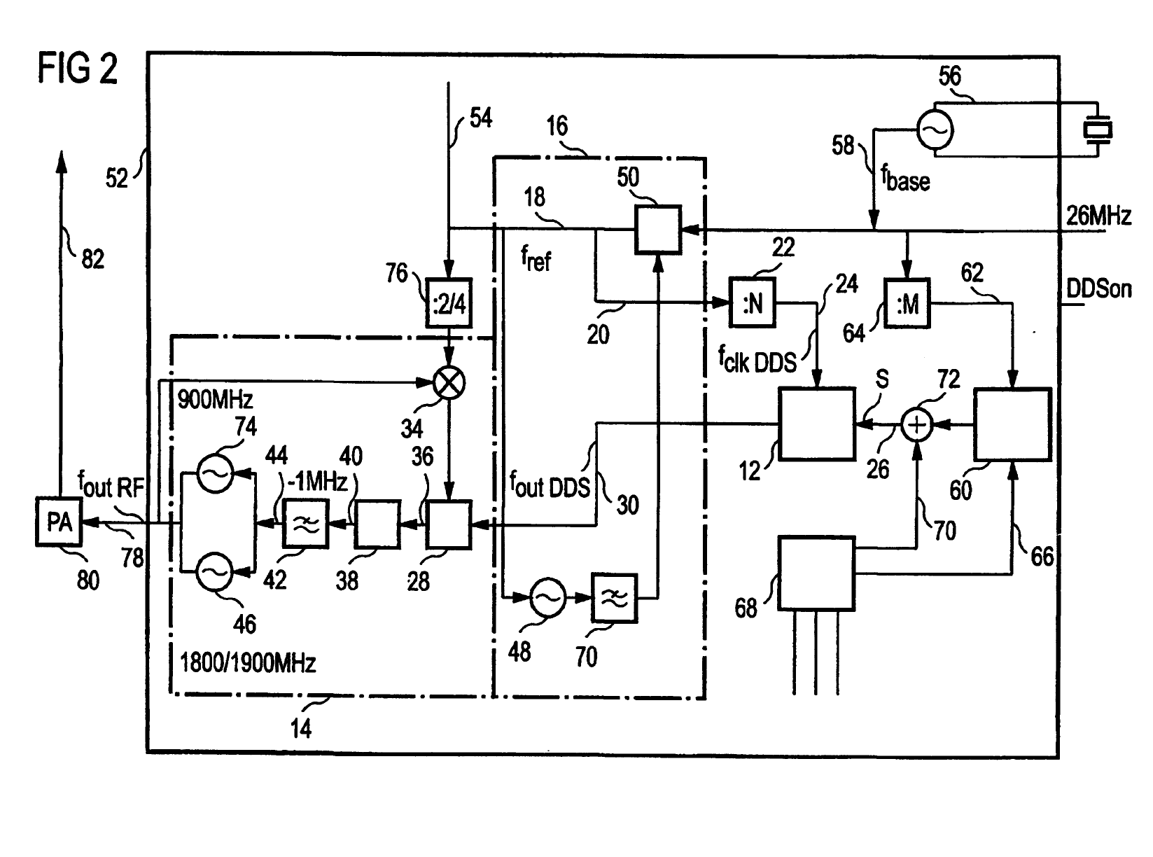

FIG. 2 is a block diagram showing the transmit circuitry of an integrated RF transceiver chip having a circuit design according to the invention.

FIG. 1 shows a circuit arrangement according to the invention with the general designation 10. It incorporates a DDS (direct digital synthesizer) 12 which is followed by a modulator implemented as an offset PLL (offset phase locked loop) 14. A signal with a reference frequency f_{ref} is fed via the line 18 into the offset PLL 14 from a channel synthesizer 16. This signal with the reference frequency f_{ref} is additionally tapped off via the line 20 and fed to a frequency divider 22. In the frequency divider 22, the frequency f_{ref} is divided down by a division factor N to provide a signal with a frequency f_{clk-DDS} which is fed via the line 24 to the DDS 12 as a clock signal. The signal frequencies are given by:

f_{ref}=N·f_{clk-DDS}

The arrangement according to the invention for generating mobile radio signals operates as follows:

To generate a required intermediate frequency f_{out-DDS}, a control word S and a clock signal having a clock frequency f_{clk-DDS} are fed to the DDS via a line 26 and via a line 24 respectively. A periodic signal having the intermediate frequency f_{out-DDS}, e.g. 20 MHz, is generated in the DDS 12 by incrementing a counter having a specified maximum count value (phase accumulator width) by the specified control word S on each clock pulse specified by the clock frequency f_{clk-DDS} until the maximum count value (phase accumulator width) is reached or exceeded. The counter is then reset, the value by which the maximum count was exceeded during incrementation possibly being adopted for re-incrementing the counter after the reset. The counter is then incremented again. The incrementing progress or the reaching of the maximum value is used to generate a periodic signal with the intermediate frequency Pout-DDS This periodic signal with intermediate frequency f_{clk-DDS} is then upconverted to a transmit frequency f_{out-RF} via the offset PLL circuit 14. For this purpose a phase detector 28 first registers the phase difference between the signal with the intermediate frequency Pout-DDS fed out via the line 30 from the DDS and the comparison signal fed out on the line 32 to said phase detector 28. This comparison signal is produced by mixing the mobile radio output signal having the frequency f_{out-RF} and the reference signal having the frequency f_{ref} via a mixer 34.

The signal fed out by the phase detector 28 via the line 36 is fed to a charge pump 38 via which a loop filter 42 is controlled via the line 40.

The output signal of the loop filter 42 is fed out via the line 44 to control a voltage controlled oscillator 46 with a center frequency of e.g. 1800 MHz.

As illustrated in FIG. 1, one and the same oscillator, namely the oscillator 48 assigned to the channel synthesizer 16, is ultimately used for generating the reference signal for the offset PLL 14 and for generating the clock signal for the DDS 12. Its output frequency is upconverted to the reference frequency f_{ref} via another phase locked loop 50, thereby obviating the need to provide a separate oscillator for generating a signal with the clock frequency f_{clk-DDS} for the DDS 12 when designing the circuit 10. This simplifies the layout of the arrangement according to the invention and improves circuit performance.

FIG. 2 now illustrates an application of the circuit according to the invention shown in FIG. 1. To facilitate the description and avoid repetitions, the same reference characters will be used for identical or similar components to those described in FIG. 1.

FIG. 2 schematically illustrates a transceiver chip 52, only the circuit design relevant to the transmission of mobile radio signals being show. However, it should be noted that there exists a connection via the line 54 to receive mixers and therefore to the circuit sections relevant to the reception of mobile radio signals.

FIG. 2 now shows—partly indicated by dash-dotted lines—the three main components of the invention, namely the DDS 12, the offset PLL 14 and the channel synthesizer 16. FIG. 2 also shows how these components are incorporated into the circuit design of the transceiver chip 52.

Derived from a crystal-controlled oscillator 56 used as a frequency standard, a signal with a base frequency f_{base} of e.g. 26 MHz is injected into the circuit via a line 58. Using a division factor M, the signal's frequency is divided down e.g. to a frequency of 2.16 MHz by means of a frequency divider 64 before being fed via a line 62 to a modulator 60.

The modulator 60 is controlled via a line 66 by a control unit 68. The modulator 60 can be a GMSK modulator, for example. Via a line 70, the control unit 68 additionally controls an adder 72 which adds an output signal from the modulator 60 and an output signal from the control unit 68 to produce the control word S which is in turn fed via the line 26 to the DDS 12.

The signal with the base frequency f_{base} is additionally fed to the phase locked loop PLL 50 of the channel synthesizer 16 as a reference signal. The PLL 50 interacts, in the manner already described with reference to FIG. 1, with the voltage controlled oscillator 48 which produces, for example, a signal with a frequency of 3.6 GHz. The oscillator 48 is followed by a loop filter 70.

The output signal of the PLL 50 with reference frequency f_{ref} is fed via the line 18 to the offset PLL 14 and via the line 20 to the frequency divider 22. As explained above, the reference frequency f_{ref} is divided down by means of the frequency divider 22 with division factor N to the clock frequency f_{clk-DDS} which is fed via the line 24 to the DDS 12 as the clock signal frequency.

Based on the control word S injected via the line 26 and the clock frequency f_{clk-DDS} fed in via the line 24, the DDS 12 generates a signal with the intermediate frequency f_{out-DDS} which is fed to the PLL 14 via the line 30. As described above with reference to FIG. 1, this signal with the intermediate frequency f_{out-DDS} is further processed in the PLL 14, or more precisely via its components, namely phase detector 28, charge pump 38, loop filter 42 and oscillator 46.

It should be noted that, depending on the required transmit frequency, in the embodiment illustrated in FIG. 2 two oscillators are provided in the offset PLL 14, namely the oscillator 46 and the oscillator 74, the oscillator 46 having a center frequency designed to provide transmit frequencies in the 1800 or 1900 MHz range, whereas the oscillator 74 is designed to have a center frequency in the 900 MHz range. Providing two oscillators of this kind with these frequency ranges is required, for example, for the operation of a mobile telephone in three different GSM networks.

It should also be noted that the reference frequency f_{ref} fed out via the line 18 is first divided down via a variably adjustable frequency divider 76 depending on the active state of the oscillators 46 and 74 before being fed to the offset PLL 14 and injected into the mixer 34.

The output signal with the transmit frequency f_{out-RF} is fed via a line 78 to a power amplifier 80 of the output stage and amplified. From here the transmit signal is fed to an antenna 82 and radiated in the form of electromagnetic waves.

The foregoing description relating to FIG. 2 shows one possibility for incorporating the circuit design according to the invention in a transceiver chip 52 for a mobile radio terminal in such a way that, using simplified circuitry, good reproducibility combined with a high level of circuit performance can be achieved. As described with reference to FIG. 1, the reference frequency f_{ref} of the channel synthesizer 16 is in turn used to control the offset PLL 14 and also—after division down by means of frequency divider 22—to clock the DDS 12.

1. Method for generating mobile radio signals using a DDS (12) (direct digital synthesizer) and a modulator (14), comprising the following steps:
A) Generating an intermediate frequency (f_{out-DDS}) by controlling the DDS (12) with a DDS control word (S) and a DDS clock frequency (f_{clk-DDS}) and
B) Converting the intermediate frequency (f_{out-DDS}) to a transmit frequency (f_{out-RF}) of the mobile radio signals using the modulator (14) as a function of a reference frequency (f_{ref}) of the modulator (14),
characterized in that the reference frequency (f_{ref}) of the modulator (14)—unchanged or divided by a division factor (N)—is used as DDS clock frequency (f_{clk-DDS}), the DDS control word (S) being selected to generate the intermediate frequency (f_{out-DDS}) in such a way that it compensates variations in the reference frequency (f_{ref}) of the modulator (14).

2. Method according to claim 1,
characterized in that the reference frequency (f_{ref}) of the modulator (14) is produced by a channel synthesizer (16) for generating frequency channels for the mobile radio signals.

3. Method according to claim 2,
characterized in that the reference frequency (f_{ref}) of the modulator (14) is generated in the channel synthesizer (16) by converting a variable output frequency to the reference frequency (f_{ref}).

4. Method according to one of the preceding claims, characterized in that the DDS control word (S) is determined from the following equation:
S=[f_{out-DDS}/f_{clk-DDS}]·2^{N},
where
S is the control word,
f_{out-DDS} the intermediate frequency,
f_{clk-DDS} the DDS clock frequency and
N the phase accumulator width of the DDS.

5. Method according to one of claims 1-3,
characterized in that the DDS control word (S) is determined from a previously stored table as a function of the current DDS clock frequency (f_{clk-DDS}) and the required intermediate frequency (f_{out-DDS}).

6. Method according to one of the preceding claims, characterized in that the DDS control word (S) is generated from an output signal of another modulator (60), specifically a GMSK modulator.

7. Arrangement (52) for generating mobile radio signals, specifically according to the method according to one of the preceding claims, comprising:
a DDS (12) (direct digital synthesizer) for generating an intermediate frequency (f_{out-DDS}) from a DDS control word (S) and a DDS clock frequency (f_{clk-DDS}) and
a modulator (14) for converting the intermediate frequency (f_{out-DDS}) to a transmit frequency (f_{out-RF}) of the mobile radio signals as a function of a reference frequency (f_{ref}) of the modulator (14),
characterized in that the DDS clock frequency (f_{clk-DDS}) is derived from the reference frequency (f_{ref}) of the modulator (14) and that the DDS control word is selected according to the reference frequency (f_{ref}) of the modulator (14).

8. Arrangement (52) according to claim 7,
characterized by a channel synthesizer (16) for generating frequency channels for the mobile radio signals, the output frequency (f_{ref}) of said channel synthesizer (16)—unchanged or divided by a division factor (N)—being fed to the modulator (14) as the reference frequency (f_{ref}) and to the DDS (12) as the DDS clock frequency (f_{clk-DDS}).

9. Arrangement (52) according to claim 7 or 8,
characterized in that the channel synthesizer (16) has an oscillator (48), preferably a voltage controlled oscillator (46), and a synthesizer phase locked loop (50) following said VCO.

10. Arrangement (52) according to one of claims 7 to 9, characterized by a frequency divider (22) for dividing down the reference frequency (f_{ref}) of the modulator (14) to the required DDS clock frequency (f_{clk-DDS}).

11. Arrangement (52) according to one of claims 7 to 10, characterized by a computation unit (68) for computing the DDS control word (S) according to the following relation:
S[f_{out-DDS}/f_{clk-DDS}]·2^{N}
where
S is the control word,
f_{out-DDS} the intermediate frequency,
f_{clk-DDS} the DDS clock frequency and
N the phase accumulator width of the DDS.

12. Arrangement (52) according to one of claims 7 to 10, characterized by a storage unit for storing and reading out a table giving the DDS control word (S) as a function of the DDS clock frequency (f_{clk-DDS}) and the required intermediate frequency (f_{out-DDS}).

13. Arrangement (52) according to one of claims 7 to 12, characterized in that the modulator (14) is implemented as a phase locked loop (14), specifically as an offset PLL.

14. Arrangement (52) according to one of claims 7 to 13, characterized by another modulator (60), specifically a GMSK modulator preceding the DDS (12) and used for generating a DDS control word (S).

15. Arrangement (52) according to one of claims 7 to 13, characterized by a control unit (68) for controlling the additional modulator (60), the DDS (12), and the channel synthesizer (16).
